(19) United States
(12) Patent Application Publication
(10) Pub. No.: US 2009/0073148 A1
(43) Pub. Date: Mar. 19, 2009

(54) Level shifter, interface driver circuit and image display system

(75) Inventor: Fu-Yuan Hsueh, ChuNan (TW)

Correspondence Address: LIU & LIU, 444 S. FLOWER STREET, SUITE 1750, LOS ANGELES, CA, 90071, US

(73) Assignee: TPO Displays Corp., ChuNan (TW)

(21) Appl. No.: 12/217,228

(22) Filed: Jul. 2, 2008

(30) Foreign Application Priority Data
Jul. 3, 2007 (TW) 96124095

(51) Int. Cl. G06F 3/038

(52) U.S. Cl. 345/204

(57) ABSTRACT

The present invention relates to a level shifter receiving a control signal to produce a first and a second driving voltage, comprising a first and a second capacitor, and a first and a second self-bias circuit for respectively providing a supply path to couple to a direct current bias voltage source, and charging the first and the second capacitor, wherein the first and the second capacitor can boost the control signal to produce the first and the second driving voltage respectively. The present invention also provides an image display system, comprising an interface driver circuit that uses the first and the second driving voltage produced by the level shifter to generate a high-level voltage output signal.

### BACKGROUND OF THE INVENTION

1. Field of the Invention

The present invention relates to a level shifter, interface driver circuit and image display system, more particularly, a level shifter used in voltage level control in interface driver circuit and image display system.

2. Description of the Related Art

Generally, to minimize power loss, control signals are usually transmitted at low level in electronic systems, and in order to drive the back-end load circuit, the control signal is converted to a high-level signal before being transmitted to the back-end load circuit through the use of a level shifter.

FIG. 4 shows the circuit diagram of a conventional level shifter, which comprises PMOS transistors M1, M3 and NMOS, and transistors M2, M4. The input signal V_{IN} is linked to NMOS transistor M2, and its inverted signal is linked to NMOS transistor M4, while NMOS transistors M2, M4 are serially connected to PMOS transistors M1, M3 respectively to connect to a direct current voltage source V_{DD}.

When input signal V_{IN} is at low level, NMOS transistor M2 would be off, and NMOS transistor M4 would be on. Thus the voltage level at node B is V_{SS}, which enables transistor M1 to turn on, and the voltage level at node A is elevated to V_{DD}, which enables transistor M3 to turn off. Consequently, driver transistor M6 is turned on, which enables the voltage level of voltage output signal V_{OUT} to be V_{SS}.

When input signal V_{IN} is at high level, NMOS transistor M2 would be on, and NMOS transistor M4 would close gradually, which enables the voltage level at node A to drop to V_{SS}. Thus transistor M3 turns on, which enables the voltage level at node B to be elevated to V_{DD}. Consequently, transistor M1 also closes gradually, which enables driver transistor M5 to turn on, and the voltage level of voltage output signal V_{OUT} would increase to V_{DD}.

However, the transmission of control signal at higher voltage level incurs greater power loss. Thus the majority of hand-held devices available use power-saving mode or low-power control signal. In the case of hand-held devices using thin-film transistor liquid crystal display (TFT LCD) that consumes more power, the voltage level of control signal (main clock, MCK) of its interface driver circuit must be lowered from the common level of 2.5V to 1.3V. However, in the conventional level shifter framework, 1.3V control signal is unable to drive the voltage output signal that originally operates in the high frequency of 5V.

FIG. 5 shows the circuit diagram of a conventionally known improved interface driver circuit, which contains two sets of level shifters 51, 52 connected in parallel; one is used by an asynchronous level shifter 53 for horizontal synchronization (Hsync), and the other is used by a logic circuit 54 for generating reset pulse. The improved interface driver circuit generates multiple sets of voltage output signals, and a plurality of switches 55 choose one voltage output signal and provide it to the output circuit 56.

Although the aforesaid improved interface driver circuit can use low-level MCK signal to generate a high-level voltage output signal, the circuit framework of such is enormous, requiring three sets of level shifters to generate the required voltage output signal. Thus it is not suitable for the use in compact-size hand-held devices.

### SUMMARY OF THE INVENTION

The object of the invention is to provide a level shifter, interface driver circuit and image display system using low-level control signal to control and drive a high-level voltage output signal.

To achieve the aforesaid object, the invention provides a level shifter for receiving a control signal to generate a first and a second driving voltage, comprising a first and a second capacitor; and a first and a second self-bias circuit for respectively providing a supply path to couple to a direct current bias voltage source, and charging the first and the second capacitor, wherein the first and the second capacitor can boost the control signal respectively to produce the first and the second driving voltage.

To achieve the aforesaid object, the invention further provides an interface driver circuit that receives a control signal and generates a voltage output signal, comprising a driver circuit having a first and a second driver transistor to control the voltage level of the voltage output signal respectively; and a level shifter for receiving and boosting the control signal to control the gate voltage of the first and second driver transistors of the driver circuit respectively; the level shifter comprises a first and a second capacitor, as well as a first and a second self-bias circuit to respectively provide a direct current bias voltage source to the supply path of the gate of the first and second driver transistors, and to charge the first and the second capacitors respectively, wherein the first and the second capacitor can boost the control signal to produce the gate voltage of first and second driver transistors respectively.

To achieve the aforesaid object, the present invention provides an image display system, comprising an interface driver circuit for receiving a control signal and generating a voltage output, within which includes a driver circuit having a set of serially connected first and second driver transistors for controlling the level of the voltage output; and a level shifter for receiving and boosting the control signal to control the gate voltage of the first and second driver transistors of the driver circuit; within which the level shifter includes a first and second capacitors; a first and a second PMOS transistors to provide a direct current voltage source to the supply path of the gate of the first and second driver transistors respectively, and to charge the first and the second capacitors respectively; and a first and a second PMOS diode-connected transistor parallel connecting to the first and the second PMOS transistors respectively to control respectively the voltage level of gate of the first and second driver transistors provided by the direct current voltage source; wherein the first and the second capacitors boost the control signal to generate the gate voltage of the first and second driver transistors respectively.

The interface driver circuit of the invention uses only a level shifter, a driver circuit and a simple circuit framework to control and drive a voltage output signal at the high level of about 5V with a low-level control signal of about 1.3V under 200 ns duty cycle and high operating frequency.

The object and features of the invention are described in detail with accompanying drawings below. The accompanying drawings and examples cited below are for illustration only and not meant to limit the actual application of the invention.

### BRIEF DESCRIPTION OF THE DRAWINGS

FIG. 1 is the circuit diagram of an interface driver circuit according to an embodiment of the invention.

FIG. 2 is the waveform of output voltage of an interface driver circuit according to an embodiment of the invention.

FIG. 3 shows another embodiment of the image display system according to the invention.

FIG. 4 is the circuit diagram of a conventional level shifter.

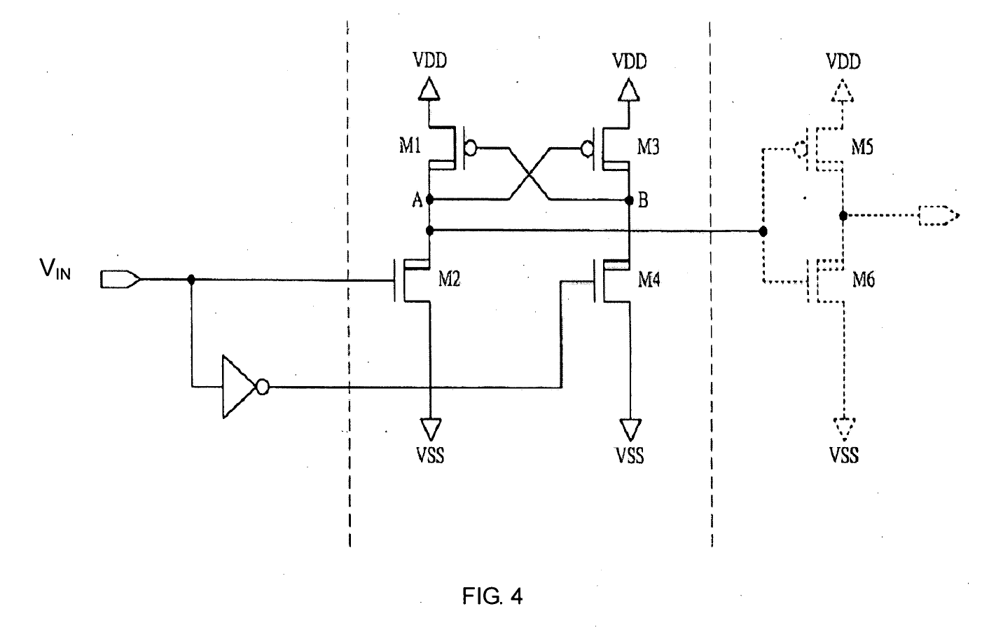

FIG. 5 is the circuit diagram of a conventionally known improved interface driver circuit.

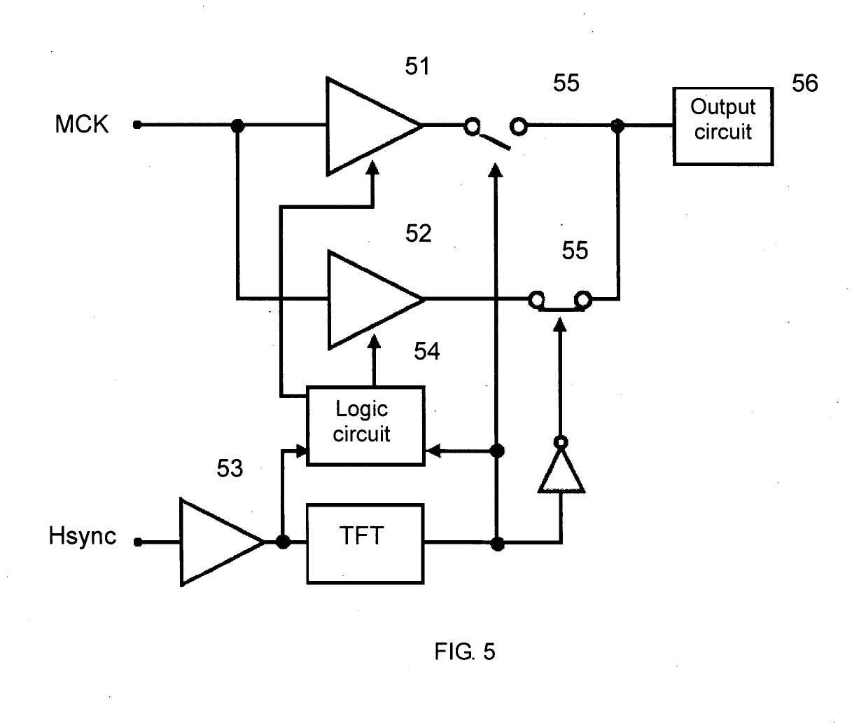

### DETAILED DESCRIPTION OF THE INVENTION

The preferred embodiments of the present invention are fully illustrated with accompanying drawings. However, the examples should not be construed as a limitation on the actual applicable scope of the invention, and as such, all modifications and alterations without departing from the spirits of the invention and appended claims shall remain within the protected scope and claims of the invention.

The present invention relates to an interface circuit driver that uses a level shifter to receive a low-level control signal input and couples a driver circuit to generate a high-level voltage output signal.

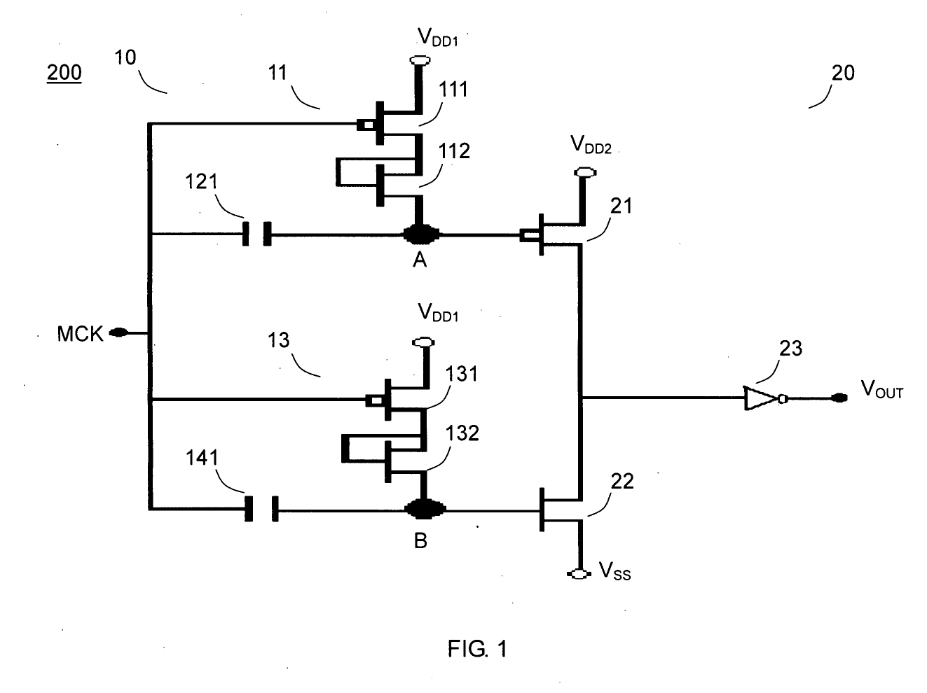

FIG. 1 shows the circuit diagram of an interface driver circuit according to an embodiment of the invention. As shown on the diagram, an interface driver circuit 200 comprises a level shifter 10 and a driver circuit 20. The driver circuit 20 comprises two sets of serially connected thin-film transistors (TFT) 21, 22. The driver circuit 20 receives a high-level direct current voltage source V_{DD2} and a low-level direct current voltage source V_{SS}, and generates a voltage output signal V_{OUT} at the level ranging between the voltage level of direct current voltage source V_{DD2} and direct current voltage source V_{SS} via an inverter 23. When transistor 21 is on and transistor 22 is off, the driver circuit 20 outputs a high-level voltage output signal V_{OUT} from direct current voltage signal V_{DD2}. When transistor 21 is off and transistor 22 is on, the driver circuit 20 outputs a low-level voltage output signal V_{OUT} from direct current voltage signal V_{SS}.

The level shifter 10 receives a control signal MCK to control the driver circuit 20. The level shifter 10 further comprises two self-bias circuits 11, 13 and two capacitors 121, 141. The self-bias circuits 11, 13 respectively comprise a PMOS transistor 111, 131 serially connected to a diode-connected transistor 112, 132. The transistors 111, 131 receive a direct current voltage source V_{DD1} to form a supply path from direct current voltage source V_{DD1} to node A and node B respectively, and use the control signal MCK to control the ON/OFF of transistors 111, 131 and in turn control the ON/OFF of corresponding supply path.

The capacitors 121, 141 temporarily store the voltage level of node A and node B respectively and provide a boost voltage to node A and node B when the supply paths of self-bias circuits 11, 13 are closed. Since node A and node B are connected respectively to the gate of transistors 21, 22 of driver circuit 20, level shifter 10 would be able to control the voltage at node A and node B through self-bias circuits 11, 13 and capacitors 121, 141, and further control the ON/OFF of transistors 21, 22 of driver circuit 20.

In an embodiment of the invention, when control signal MCK outputs a low-level voltage signal, i.e. when the output is L (logic 0), transistors 111, 131 are on. And since diode-connected transistors 112, 132 are in saturation mode, the voltage level at node A and node B can be expressed by the following equation:

V_{A}=V_{DD1}−V_{Dsat1}

V_{B}=V_{DD1}−V_{Dsat2}

Where V_{Dsat1} and V_{Dsat2} are the saturation voltages of diode-connected transistors 112, 132 respectively, and the voltages, V_{Dsat1} and V_{Dsat2} are associated with the dimensions of diode-connected transistors 112, 132 as shown by the equations below:

$${V}_{Dsat} = {V}_{t} + \sqrt{\frac{2 {I}_{D}}{β}}$$

$$β = \frac{KW}{2 L}$$

Thus, the voltage at node A and node B can be controlled by changing the dimension of diode-connected transistors 112, 132. Capacitors 121, 141 can also store the voltages of node A and node B.

When control signal MCK outputs a high-level voltage signal, i.e. when the output is H (logic 1), transistors 111, 131 are off. Since the supply paths are closed, the voltage value V_{MCKH} of control signal MCK is supplied to node A and node B through capacitors 121, 141, while the voltage stored at capacitors 121, 141 are also supplied to the corresponding node A and node B. Hence the voltage value at node A and node B can be expressed by the following equations:

V_{A}=V_{MCKH}+(V_{DD1}−V_{Dsat1})

V_{B}=V_{MCKH}+(V_{DD1}−V_{Dsat2})

Wherein, when the voltage signal of control signal MCK is V_{DD1}, the voltage value at node A and node B can be expressed by the following equations:

V_{A}=2V_{DD1}−V_{Dsat1}

V_{B}=2V_{DD1}−V_{Dsat2}

The ON/OFF of transistors 21, 22 of driver circuit 20 can be controlled by the voltage-driven gate potential at node A and node B, thereby controlling the inverter 23 of driver circuit 20 to output a high-level or a low-level voltage output signal V_{OUT}.

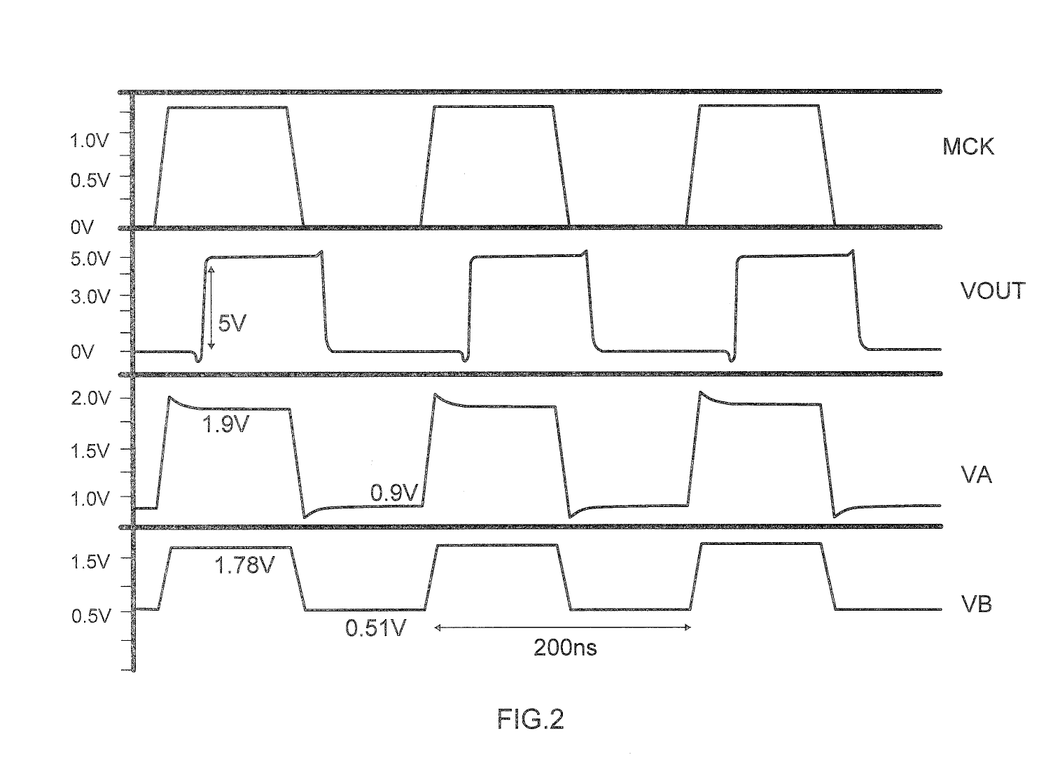

Referring to FIG. 2 which shows the waveform of output voltage of the interface driver circuit according to an embodiment of the invention, the level shifter 10 receives a low-level direct current voltage source V_{DD1} at about 1.3V, and the saturation voltage of diode-connected transistors 112, 132 is 0.77V and 1.16 v respectively, while the voltage level of control signal MCK lies between 0 and 1.3V.

When the output of control signal MCK is 0V, node A and node B are at low voltage level of about 0.9V and 0.51V respectively, which enables transistor 21 to turn on and transistor 22 to turn off. As such, the voltage output signal output by inverter 23 is 0V. When the output of control signal MCK is 1.3V, node A and node B are at high voltage level of about 1.9V and 1.78V respectively, which enables transistor 21 to turn off and transistor 22 to turn on. As such, the voltage output signal output by inverter 23 is 5V.

As shown in FIG. 2, the interface driver circuit 200 can use a level shifter 10 to receive a low-level control signal MCK of about 1.3V, and drive a voltage output signal V_{OUT} of as high as 5V. Furthermore, the interface driver circuit 200 can drive a voltage output signal at the high level of about 5V with a low-level control signal MCK under 200 ns duty cycle and high operating frequency.

In an embodiment of the present invention, the use of different dimensions of diode-connected transistors 112, 132 enables node A and node B to generate different driving voltage to alternately drive the transistors 21, 22 of driver circuit 20.

In an embodiment of the present invention, the use of different gate driving voltages can control the ON/OFF of diode-connected transistors 21, 22 with different dimensions.

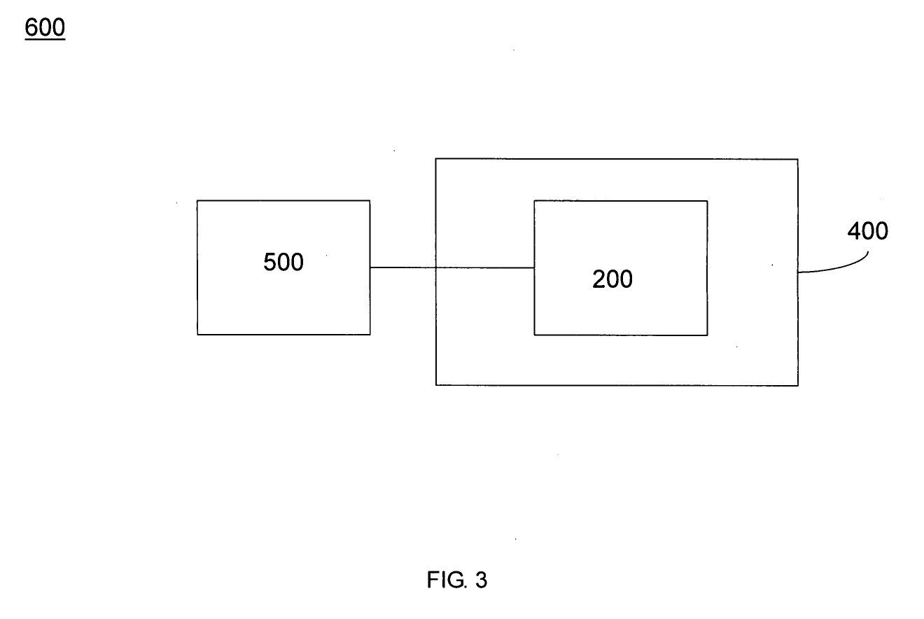

FIG. 3 illustrates an image display system according to another embodiment of the invention, within which is an image display system 600 comprising a display panel 400 and a power supplier 500. The display panel 400 can be a part of an electronic device and contains the interface driver circuit 200. The power supplier 500 is coupled to the display panel 400 to supply electrical power to the display panel 400. The image display system 600 can be a mobile phone, digital camera, personal digital assistant (PDA), notebook computer, desktop computer, television, global positioning system (GPS), automobile display, aviation display monitor, digital photo frame or portable DVD player.

According to an embodiment of the present invention, the interface driver circuit and image display system of the invention comprises only a level shifter, a driver circuit and a simple circuit framework to control and drive a voltage output signal at the high level of about 5V, with a low-level control signal of about 1.3V under 200 ns duty cycle and high operating frequency.

The preferred embodiments of the present invention have been fully illustrated. However the examples should not be construed as a limitation on the actual applicable scope of the invention, and as such, all modifications and alterations without departing from the spirits of the invention and appended claims shall remain within the protected scope and claims of the invention.

What is claimed is:

1. A level shifter for receiving a control signal to generate a first and a second driving voltage, comprising:
a first and a second capacitor; and
a first and a second self-bias circuit for respectively providing a supply path to couple to a direct current bias voltage source and charging the first and the second capacitor;
wherein the first and the second capacitor can respectively boost the control signal to generate the first and the second driving voltages respectively.

2. The level shifter according to claim 1, wherein the first and the second self-bias circuit comprise a PMOS transistor and a diode-connected transistor respectively.

3. The level shifter according to claim 2, wherein the PMOS transistor is serially connected to the diode-connected transistor, and receives the direct current bias voltage source to form the supply path.

4. The level shifter according to claim 2, wherein the control signal is used to control the ON/OFF of the PMOS transistor to further control the ON/OFF of the supply path.

5. The level shifter according to claim 1, wherein the first and the second self-bias circuits are respectively parallel connected to the first and the second capacitor.

6. The level shifter according to claim 1, wherein one end of the first and the second capacitor is respectively coupled to the control signal so that the first and the second capacitor can boost the control signal so as to generate the first and second driving voltages respectively.

7. The level shifter according to claim 6, wherein the first and the second capacitors are respectively coupled to the supply path at another end and generates the driving voltage at the other end respectively.

8. An interface driver circuit for receiving a control signal and generating a voltage output signal, comprising:
a driver circuit having a first and a second driver transistor to control the level of the voltage output signal; and
a level shifter for receiving and boosting the control signal to control the gate voltage of the first and the second driver transistors of the driver circuit;
wherein the level shifter comprises:
a first and a second capacitor; and
a first and a second self-bias circuit for respectively providing a direct current bias voltage source to the supply path of the gate of the first and the second driver transistors, and charging the first and the second capacitor respectively;
wherein the first and the second capacitor can respectively boost the control signal to generate the gate voltages of the first and the second driver transistors respectively.

9. The interface driver circuit according to claim 8, wherein the first and the second driver transistors are a thin-film transistor.

10. The interface driver circuit according to claim 8, wherein the driver circuit further receives a high-level direct current driving voltage source.

11. The interface driver circuit according to claim 8, wherein the driver circuit further receives a low-level direct current driving voltage source.

12. The interface driver circuit according to claim 8, wherein the first and the second driver transistors have different dimensions.

13. The interface driver circuit according to claim 8, wherein the first and the second self-bias circuits further comprise a PMOS transistor and a diode-connected transistor respectively.

14. The interface driver circuit according to claim 8, wherein the PMOS is serially connected to the diode-connected transistor and receives the direct current bias voltage source to form the supply path.

15. The interface driver circuit according to claim 8, wherein the control signal is used to control the ON/OFF of the PMOS transistor to further control the ON/OFF of the supply path.

16. An image display system, comprising:
an interface driver circuit for receiving a control signal and generating a voltage output signal;
a driver circuit having a set of serially connected first and second driver transistors to control the level of the voltage output; and
a level shifter for receiving and boosting the control signal to control the gate voltage of the first and second driver transistors of the driver circuit;
wherein the level shifter comprises:
a first and a second capacitors;
a first and a second PMOS transistors for respectively providing a direct current voltage source to the supply path of the gate of the first and second driver transistors, and charging the first and the second capacitor respectively; and
a first and a second diode-connected transistor parallel connected to the first and the second PMOS transistors respectively so as to control the voltage level of the gate of the first and second driver transistors provided by the direct current voltage source;
wherein the first and the second capacitors can respectively boost the control signal to generate the gate voltages of the first and the second driver transistors respectively.

17. The image display system according to claim 16, wherein the first and the second driver transistors are respectively a thin-film transistor.

18. The image display system according to claim 16, wherein the driver circuit further receives a high-level direct current driving voltage source.

19. The image display system according to claim 16, wherein the driver circuit further receives a low-level direct current driving voltage source.

20. The image display system according to claim 16, wherein the first and the second driver transistors have different dimensions.

21. The image display system according to claim 16, wherein the first and the second diode-connected transistors have different dimensions.

22. The image display system according to claim 16, wherein the driver circuit further includes an inverter to invert the phase of the voltage output signal.

23. The image display system according to claim 16, further comprising a display panel, wherein the interface driver circuit is a part of the display panel.

24. The image display system according to claim 23, further comprising a power supplier coupling to the display panel and supplying electrical power to the display panel.

25. The image display system according to claim 16, wherein the image display system is a mobile phone, a digital camera, a personal digital assistant (PDA), a notebook computer, a desktop computer, a television, a global positioning system (GPS), a car display, an aviation display monitor, a digital photo frame or a portable DVD player.
